(19) United States
(12) Patent Application Publication
(10) Pub. No.: US 2015/0355736 A1
(43) Pub. Date: Dec. 10, 2015

(54) A CONTROL INPUT SYSTEM

(71) Applicant: TKS A/S, Aalborg (DK)

(72) Inventor: Gert Spender-Andersen, Vestbjerg (DK)

(73) Assignee: TKS A/S, Aalborg (DK)

(21) Appl. No.: 14/759,485

(22) PCT Filed: Jan. 13, 2014
(86) PCT No.: PCT/DK2014/050005

§ 371 Date: Jul. 7, 2015

(30) Foreign Application Priority Data
Jan. 11, 2013 (DK) PA 2013 70015

(51) Int. Cl. G06F 3/0354

(52) U.S. Cl. CPC G06F 3/03547; G06F 3/03545; G06F 2203/0331

(57) ABSTRACT

A control input system comprising: an input unit comprising, a ferromagnetic material medium, a non-invasive detachable attachment means for attaching the ferromagnetic medium to the hand of the user; a control unit comprising, a control input area defining the input interface for interaction with the ferromagnetic medium, a sensor unit capable of registering the position of N the ferromagnetic medium of the input unit relative to the control unit and providing at least one sensor output signal, a signal processor for converting the at least one sensor output signal to a control output signals representing the position of the ferromagnetic material relative to the control input, a signal transmitter for transmitting processed signals to an external device, and a housing for enclosing the sensor unit, the signal process and/or the signal transmitter.

### FIELD OF THE INVENTION

A control input system comprising an input unit comprising a ferromagnetic material medium, and a control unit for registering the movements of the ferromagnetic medium.

### BACKGROUND

Persons with movement disabilities due to spinal cord injuries, brain injuries or other impairments of the motoric system may be greatly affected in everyday life, as their lack of motoric skills may reduce their abilities of interacting with external aids such as computers, telephones, wheelchairs, etc. via standardized user interfaces.

The interaction with external aids may be very important for persons with movement disabilities; as such external aids may assist the persons in living on a self-supportive independent basis and may have a huge impact on their quality of life.

There exists a vast amount of assistive technologies that may be used to improve the quality of life for persons with impairments to the motoric system, such as breath controlled wheelchairs, for persons that have very limited motoric skills, such as tetraplegics that have lost their motoric skills in their torso, legs and arms. However, breath controlled wheelchairs may have a relative small input range, which means that the breath control can only be used in a limited manner, and may only be used to control simple functions.

One method of improving control input for tetraplegics is disclosed in WO 2006/105797 where a system for tongue based control of computers and/or aids for severely disabled persons, where a magnetic responsible material is fixed to the tongue and the movements of the material is tracked using a coil that may be arranged in the mouth cavity, that is capable of interacting with the magnetic material. The use of such a system may be seen as quite invasive for some users, as the magnetic material is often in the form of a stud that is pierced into the tongue, which may be unattractive for some users.

Conditions that may be seen as degenerative towards the motoric skills, where the loss of motoric skills may be gradual, due to neural disorders that impair the signal transmission from the brain to the spine, and/or from the spine to the extremities. Such persons may have some sensoric/motoric signal transmission into their arms, where the persons may have limited control of their hands or their fingers. Such persons may often be assisted in their interaction with external components by arranging a touchpad, mouse, or similar touch based control input where the tips of the fingers may be used to provide control input. Touchpads operate in one of several ways, including capacitive sensing and conductance sensing. The most common technology used entails sensing the capacitive virtual ground effect of a finger, or the capacitance between sensors. Capacitance-based touchpads will not sense the tip of a pencil or other similar implement. Gloved fingers may also be problematic.

A drawback to such a system may be seen as where skin on the users fingers is too dry, which means that the capacitive effect of the finger cannot be registered by the touchpad, in that the capacitive effect is reduced significantly. Yet further, should the finger be too moist, the finger may reduce the resolution of the touchpad, which reduces the user's ability to provide an accurate control input. Such a problem may not be problematic for fully abled persons, as the skin may easily be moistened or dried, depending on the specific situational requirements. However, for persons with, it is quite difficult to moisten or dry the fingers without help from others.

Therefore, there is a need for an improved control input interface for persons having severe disabilities and only have movement in the tip of their fingers, where the quality and/or the resolution of their input is not dependent on the moisture content of their fingers.

### GENERAL DESCRIPTION

In accordance with the invention, there is provided a control input system comprising:
an input unit comprising, a ferromagnetic material medium, a non-invasive detachable attachment means for attaching the ferromagnetic medium to the hand of the user; a control unit comprising, a control input area defining the input interface for interaction with the ferromagnetic medium, a sensor unit capable of registering the position of the ferromagnetic medium of the input unit relative to the control unit and providing at least one sensor output signal, a signal processor for converting the at least one sensor output signal to a control output signals representing the position of the ferromagnetic material relative to the control input, signal transmitter for transmitting processed signals to an external device, and a housing for enclosing the sensor unit, the signal process and/or the signal transmitter.

The control input device according to the invention allows severely disabled persons to provide a control input to a computer, a wheel chair, a telephone, or other devices that may be electronically controlled via an interface that may be arranged in the hands of the user. The structure of the device, in using a ferromagnetic medium that is attached to the hand of the user ensures that every movement of the medium is registered by the control unit, and that the physical attributes of the hands, such as moisture level will not interfere with the control input. Thus, users are capable of providing a control input, provided that the user is capable of moving the hand or parts of the hand relative to the control unit, where the hand is provided with the ferromagnetic medium, irrespective of the inductive capabilities of the skin surface of the user.

The known systems for control interfaces using the hands are often based on using a trackpad or touchscreen where the conductive capabilities of the skin surface are an essential part of registering the movement of the hand. Alternative ways of registering movements may be using a mouse, which registers the movement of the mouse relative to a surface, or a pointing stick, where the touch of the stick may be registered on a surface area. Such devices depend on the fact that the user has to have enough mobility in the hands to control the device, and to retrieve the device should the user lose contact with the device during use.

These drawbacks are solved using the control input system according to the invention, as the input unit is attached to the hands of the user, and the user does not have to provide motoric control to retain the input unit in contact with the hand. Thus, the limited motoric control may be used to provide input to the control unit. Furthermore, the present invention ensures that the control input provided by the ferromagnetic material is not dependent on having actual contact between the input unit and the control unit, or the control input area of the control unit, as the sensor unit according to the invention is capable of registering the position of the ferromagnetic medium even though it is not in physical contact with control unit. Thus, the user does not necessarily have to use the motoric movement to provide physical contact, but may have the input unit hovering over the control unit when providing input to the system. This means that the physical requirements of the motoric skills is significantly less than when using touchscreens or touchpads, which require actual physical contact between the control unit and the input unit.

Furthermore, for persons having reduced mobility in their arms, while still retaining some motoric control in the distal parts of their hands, may have a natural tendency of having their hands placed on their laps when seated. Such a position may be seen as a resting position of the hands, where any attempt to move the arms and/or the hands from the resting position may be strenuous and even painful for some individuals. Thus, the system according to the invention assists the aforementioned persons in providing control input to a computer, without excess use of movements and possibly in a pain-free way.

In one embodiment of the invention the control unit may further comprise a stabilising means for allowing the control unit to be reliable restricted by the user. The stabilising means ensure that the control unit may reliably be retained to/by the user, in order to ensure that the user does not have to use motoric skills to manoeuver the control unit.

The control unit may be restricted to the clothing of the user using straps, attachment means in the form of hook and loop devices, or other suitable means for restricting the control unit to the user. Furthermore, within the meaning of the invention, the stabilising means may further anchor the control unit to a part of the user's equipment, such as the hand rail of a wheelchair, or a specific mounting means for the control unit that may be attached to a wheelchair, a chair, a bed, or other forms of devices used by the user. The stabilizing means may attached to the control unit using a removeable attachment means, where the removeable attachment means may be utilized to interchange a plurality of stabilizing means, so that the control unit may be adapted to interact with a plurality of different types of stabilizing means. In one embodiment, the removeable attachment means may be e.g. a threaded opening, allowing stabilizing means having a threaded protrusion to be threaded into the threaded opening, e.g. in the same manner as a threaded bolt attaches to a threaded nut.

In one embodiment of the invention, the stabilizing means may be a hand grip, adapted to be held in the palm of the hand. The hand grip may be removeably attached to the control unit, so that the hand grip may be removed from the control unit when not needed. The hand grip may protrude from the control unit, providing a protrusion that may be held by the user when stabilizing the control unit.

In one embodiment of the invention, the hand grip may be adapted to be held in the palm of the hand. The hand grip may be ergonomically formed in a shape corresponding to an inverted palm and fingers of the hand, so that the hand grip may be gripped by the user in a natural way and without incurring unnatural pressure to the hand. The hand grip may be formed so that one side of the hand grip is adapted to the palm of the hand, while the opposite side is adapted to the inner surface of each individual fingers of the hand, when the hand is clasped. Thus, the user may use one hand to hold the hand grip, while using the other hand to control the input unit. Thus, the user only requires stabilising the control unit in using the hand grip, and does not need to provide motoric movement to move the control unit, and may therefore only be required to hold the hand grip.

In one embodiment of the invention the stabilising means may be in the form of a loop, arranged to enclose at least one finger of the hand, attaching the control unit to the hand of the user. Thus, the control unit may be attached to the hand of the user, without the user having to provide any motoric movements or efforts to stabilize the control unit. The loop may be adapted to attach the control unit in the palmar or the dorsal aspects of the hand, allowing the loop to attach the control unit to the palm of the hand or the back of the hand/fingers, depending on the requirements of the user. The loop may be adapted to enclose one or more of the fingers of the hand, where it may be preferred that the loop encloses at least the middle finger of the hand, to arrange the control unit centrally, relative to the palm or the back of the hand. However, such arrangement may be dependent on the requirements of the user, and the capabilities of the user. The loop may be adapted to enclose the index finger, middle finger, ring finger or the pinky of the hand, if required, or any combination of two or more neighbouring fingers if required. Furthermore, the loop may be adapted to enclose the thumb of the hand, should the user require such stabilisation.

In one embodiment of the invention, the attachment means may comprise an arrangement for attaching the input unit to the tip of a finger. The input unit may be attached to the tip of the finger, to allow the user to utilize the fine motoric skills to control the input unit relative to the control unit. By attaching the input unit to the tip of the finger, a user that may have lost the ability to move the hand via the underarm or the wrist, but may still have some motoric abilities in the fingers, may provide control input via the input unit to the control unit. The attachment means may be in the form of a glove, parts of a glove, a finger sleeve, a strap, a thimble like attachment, or similar manners of attaching the ferromagnetic medium to the fingertip.

In one embodiment of the invention, the control unit may comprise a first control input element wherein the physical position of the ferromagnetic material relative to the first control input, may be determined in a two dimensional plane. This means that even though the sensor unit may be capable of identifying the position of the ferromagnetic medium in a three dimensional plane, i.e. also the distance from the control unit, the sensor may be adapted to disregard one of the dimensions, so that the output of the control unit may be utilized as two dimensional controls, in a similar manner as a touchpad or a touchscreen, and may e.g. be used to control a mouse pointer on a computer, which is in the form of a two dimensional control. The third dimension may be utilized to register an action, such as a click of a mouse, by recognizing a predefined behaviour with regards to the media's distance from the control unit. i.e. if the media is moved in a certain pattern, within one of the dimensions, the processing unit may interpret the signal as a predefined input, such as a mouse click.

In one embodiment of the invention the control unit comprises a second control input element comprising a plurality of discrete control input areas, wherein the physical position of the ferromagnetic material relative to the discrete control input areas may be determined in ensuring that the position of the ferromagnetic material provides a control input to one discrete control input area at a time. The discrete control input areas may be defined in a predefined pattern, such as the numerical input to a touch telephone, where the movement of the ferromagnetic media in the area of the discrete control input, may be registered as an input to the discrete control input. Thus, the discrete control input areas may be used as a part of a keyboard in that each discrete control input area may have a predefined value. Furthermore, in order to provide a further functionality, each discrete control input may have one or more predefined values, where a predefined pattern effectuated using the input unit may be used to scroll through each of the values, and thereby choosing one of the predefined values.

In one embodiment of the invention, the control unit comprises a first surface area providing a control input area providing visual and/or tactile areas defining the input area for the first control input element and/or for the discrete control input areas for the second control input element. This means that the first and/or the second control input element may be defined in the surface are of the control unit. Thus, by touching and/or viewing the first surface area, the user is capable of seeing/feeling the area to which the control input is intended. The first control input element may be an area where the visual and/or tactile means define a four sided area where control input may be provided in two dimensions. Furthermore, the square may be provided with further visual and/or tactile means that may e.g. define the controls for a wheelchair, i.e. forward, backwards, left and right, in the form of a cross defining two axes of control, an acceleration axis and a directional axis.

The discrete control input areas may be provided with visual and/or tactile means that define each discrete control input area, so that the user may easily position the input unit in the relevant area and provide control input by looking at the area or by feeling the tactile means of the surface area.

The present invention furthermore relates to a method of providing control input comprising the steps of: providing an input unit comprising a ferromagnetic media; providing a control unit comprising, a sensor unit capable of registering the position of the ferromagnetic medium of the input unit relative to the control unit and providing at least one sensor output signal, a signal processor for converting the at least one sensor output signal to a control output signals representing the position of the ferromagnetic material relative to the control input, signal transmitter for transmitting processed signals to an external device, and a housing for enclosing the sensor unit, the signal process and/or the signal transmitter; and attaching the input unit to the hand of the user allowing the user to provide control input to the sensor unit by moving the ferromagnetic media in relative to the control unit.

Theory Behind The Sensor

The detection method used in this work is based on Faraday's law of induction for a coil, and uses variable inductance techniques. The idea is to change the inductance of an air-cored induction coil, by moving a ferromagnetic material, attached to the hand, into the core of the coils: From Faradays law, the voltage drop across an inductance can be found as:

ε=−L di/dt=−μₒ·μᵣ·N²·A/1·di/dt

Where

L=−μₒ·μᵣ·N²·A/1

L=inductance

μₒ=vacuum permeability

μᵣ=relative magnetic permeability of the core material

N=number of turns

1=is the average length of the magnetic flux path

When only air is present as the core of the inductance, μᵣ=1. As the ferromagnetic material is placed in the coil, the core becomes a combination of air and ferromagnetic material and μᵣ changes according to the magnetic permeability of the ferromagnetic material.

By applying a sine wave current, i, of constant peak-peak amplitude, a constant amplitude voltage drop E is obtained across the coil L. Introduction of the ferromagnetic material into the air gap of the coil, results in an increase of ε, which stays increased, until the material is removed. This will be utilized for activation of a command in the inductive tongue control system. The method resembles the known techniques used for displacement sensors (Göpel, W, Hesse, J. Zemel, J N “Magnetic sensors': in Sensors, a comprehensive Survey” Volume 5, VCH, Verlagsgesellschaft mbH, D-6940 Weinheim, 1989).

The method and exampled used for measuring registering the position of the ferromagnetic material is described more in detail in WO 2006/105797.

### BRIEF DESCRIPTION OF DRAWINGS

The invention is explained in detail below with reference to the drawings, in which

FIG. 1 is a perspective view of a control unit according to the invention,

FIG. 2 is a top view of a control unit according to the invention,

FIG. 3 is a perspective view of an input unit according to the invention,

FIG. 4 is a side view of one embodiment of a control input system according to the invention, and

FIG. 5 is a side view of a control input system according to the invention.

### DETAILED DESCRIPTION OF DRAWINGS

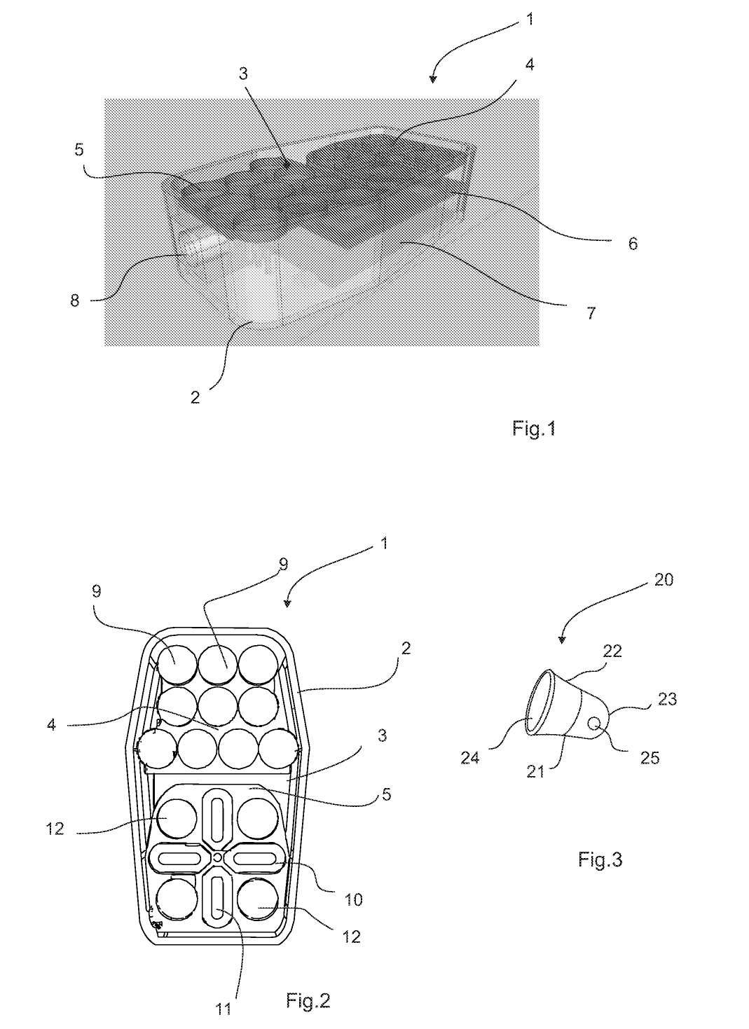

FIG. 1 shows a control unit 1 in accordance with the invention, where the control unit comprises a housing 2, that is capable of enclosing the electrical components and the electrical connections that are present in the control unit and that are necessary to provide electrical communication between the components in the control unit 1. The housing 2 may provide a liquid and/or gas proof enclosure, ensuring that any spillage or contamination onto the control unit will not affect the electrical components inside. The control unit 1 may comprise an input area 3, which may be seen a control interface, where the user may position a ferromagnetic material (not shown), where the control unit 1 further comprises a sensor unit 4, 5 that is capable of registering the position of a ferromagnetic material that is disposed in the vicinity of the sensor unit and/or input area 3.

The sensor unit 4,5 may be in the form of electrical coils, as discloses earlier in the theory section, that are capable changing the inductance depending on the position of the ferromagnetic material, emitting electrical signals that may be collected by a signal processor 6. The signal processor may be capable of interpreting the signals from the sensor unit, where the electrical signals may be translated into output signals that represent the position of the ferromagnetic material in a two- or three-dimensional coordinate system. The output signals may subsequently be transmitted to a computer or an aid, via wireless transmission, via a wireless transmission protocol, such as Bluetooth, Wifi, or other suitable wireless transmission protocols. The signal transmission from the control unit 1 may be performed by a separate signal transmission unit that is in electrical communication with the signal processor 6, or by an integrated unit that is built into the signal processor, sensor unit or any other unit in the control unit 1. The inclusion of the transmission unit in the control unit 1, may be seen as routine to a skilled person, based on the disclosure of the invention.

The control unit 1 may be powered by a rechargeable battery 7, that may be charged via a charging port 8 that may be positioned in a side wall of the housing, where the charging port may be connected to an electrical outlet via a charging cable (not shown).

The side wall of the housing may be provided with a wireless antenna that is attached to or embedded in the side wall, allowing the transmission of the wireless signals to be performed as close to the outer surface of the housing as possible, in order to reduce any transmission noise or attenuation that may occur inside the housing.

FIG. 2 shows a top view of an input area 3 of the control unit 1 in accordance with the invention. The input area may be may be provided with two separate areas of input, a first input area 4 having a first sensor unit and a second input area 5, that may be provided with a further sensor unit. However, the first and second input areas 4, 5 may utilize the same sensor unit, where the signal processor is capable of identifying if the control input belongs to the first input area 4 or the second input area 5.

The first input area 4 may be provided with a number of discrete input elements 9, where each input element may have a predefined value, such as a number, a character, or an alphabetical value. Thus, should the user place the ferromagnetic medium (not shown) in the area close to a discrete input element 9, the control input may have one or more predefined values, based on the programming of the discrete control input element.

The second input area 5 may be provided with a different type of input elements, such as a free input area that may be used to control the movement of an aid, such as an electrical wheelchair. When the ferromagnetic material is moved along a longitudinal axis 10, this may control input may control the forward and/or backwards movement of the aid, where the movement along a transverse axis 11 may control the turning of the aid, or vice versa, depending on the preference of the user. The second input area may further be provided with discrete control inputs 12, that may be arranged to control a specific function for the control of an external aid, and may be arranged at the upper and lower corners of the second input area 5, e.g. as a control input for an emergency brake, a horn, or other types of control inputs for external aids. The control unit 1 may communicate wirelessly to the external aid, and provide the communication interface between the user and the external aid.

The first 4 and/or the second input areas 5 may be provided with markings that define the position of the discrete control inputs 9, 12 and/or the longitudinal 11 and the transverse control inputs. The markings may be visual and/or tactile, so that the user is capable of seeing or feeling into what area the ferromagnetic material is being manoeuvered. The tactile marking may be provided by raising the boundaries of the control inputs 9, 10, 11, 12 so that the user may feel with the hand where the input is being provided.

The first input area 4 and the second input area 5 may be utilized as complementary control input areas, where the first input area 4 or the second input area 5 may be seen as a primary control input area where the other may be seen as an auxiliary input area. Thus the input areas may compliment each other, e.g. when the second input area 5 is used in a joystick mode for controlling a wheelchair or as a mouse, the first input area may be used as an auxiliary area that may provide specific discrete functions, such as emergency brake, horn, turn signals, etc, or as e.g. a right and left mouse click when operated as a mouse. The opposite may also be valid, when the first input area 4 is used as a keyboard input, the second input area 5 may be used to provide auxiliary functions, such as providing capabilities such as the delete and backspace buttons on a keyboard, space bar, tab, control, alt, and shift functions, etc. Thus the first 4 and second input areas 5 may be operated in a flexible manner, so that the functions of the areas may be individually defined for each user, or may be provided with a number of pre-set functionalities that may be chosen by the user.

Yet further, the first 4 and the second 5 control input areas may be configured to function as a single input area that may allow the user to provide control input along the entire combined area.

In a further embodiment, the first 4 and/or the second input area 5 may be arranged to operate as a two dimensional input area, in a similar manner to a touchpad, where the position of the ferromagnetic material may be represented in a free two dimensional area, where the side walls of the housing 2, may represent the boundary of the two dimensional area. In such operation, the input area 4, 5 may be adapted to have an area that may operate in a similar function to a mouse button, so that when the ferromagnetic material is moved into a predefined area, this is to be interpreted as a mouse click.

FIG. 3 shows a perspective view of an input unit 20 in accordance with the invention, where the input unit may comprise a body 21 having a proximal end 22 and a distal end 23, where the proximal end is provided with an opening 24. The opening may be adapted and dimensioned to receive the tip of a finger of the hand of the user, so that the body may be frictionally attached to the tip of the finger. The distal end 23 of the body may be provided with a ferromagnetic medium 25 in the form of a magnet, or other types of ferromagnetic materials, where the ferromagnetic medium 25 is attached to the body 21 of the input unit. This allows the user to attach the ferromagnetic medium in a non-invasive way to the hand, so that the hand of the user may be used to provide control input to the control unit 1, shown in FIGS. 1 and 2.

The input unit 20 may be formed in different forms, so that the ferromagnetic material may be non-invasively attached to the hand of the user, e.g. in the form of a glove having a ferromagnetic medium at the tip of the finger on the glove. Further, the ferromagnetic material may be attached to a strap, or other types of attachment means that allow the ferromagnetic material to be attached to the body.

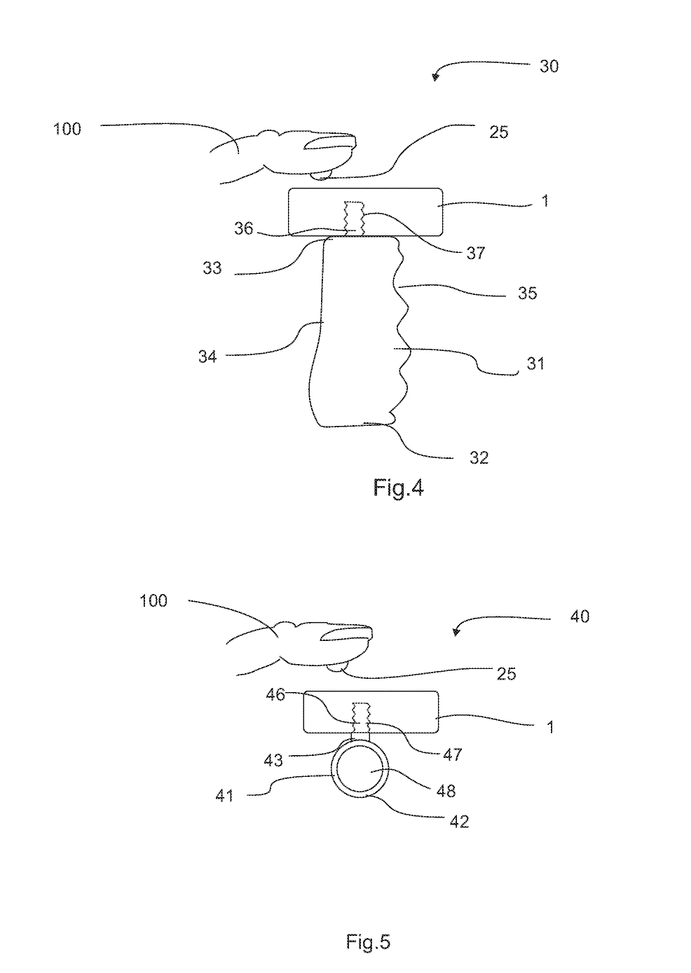

FIG. 4 shows an embodiment of the control input system 30 according to the invention, where the control unit 1 is provided with a hand grip 31. The hand grip 31 comprises a proximal end 33 and a distal end 32 where the proximal end is attached to the control unit 1. The hand grip may be provided with an ergonomic shape, where the outer surface is provided with an area 34 that is adapted to be held in the palm of the hand, where the opposing surface 35 may be provided with depressions and protrusions adapted to accommodate the fingers of the hand, allowing the user to hold onto the grip in a predefined manner reducing stress incurred by the grip 31 to the hand of the user. The proximal end 33 of the grip 31 may be provided with an attachment means 36, where housing may be provided with a mating attachment means 37. Thus, the hand grip may be removed from the control unit when needed, and e.g. be replaced with a different type of stabilizing means for attaching the control unit 1 to the user or to areas that are within reach to the user, and may be used as mounting areas for the control unit 1.

The grip 31 shown in FIG. 4 may be especially helpful for spastic persons that may have regular or irregular muscle cramps in their hands. Such persons may have problems with the function of stabilising a control unit in the palm of their hand, without any aid, as the muscle cramps could lead to the hand closing around the control unit and preventing the user in getting access to the control input area. Thus the hand grip 31 allows the person to stabilize the control unit 1, without being overly affected by muscle cramps that affect the hands of the user. Thus, when a muscle cramp may occur, the user may grip the hand grip 31 more tightly, without losing the grip of the hand grip 31.

FIG. 5 shows another embodiment of the system 40 according to the invention, which is similar to that shown in FIG. 4, where the hand grip 31 has been replaced with a ring shaped stabilizing means 41. The ring shaped stabilizing means may have a proximal end 43 and a distal end 43 where the proximal end may be attached to the control unit 1, using mating attachment means, such as a threaded bolt 46 and nut 47. The ring shaped stabilizing means 41 may be provided with an opening 48 which allows the user to slide the finger of the hand through the opening 48, allowing the control unit to be removeably attached to the hand of the user.

In both embodiments of the system 30, 40 shown in FIGS. 4 and 5, the user may use the opposite hand (not having the control unit 1) to provide control input to the control unit 1. The user may have a ferromagnetic material 25 attached to the tip of the finger 100 and may move the material 25 into the vicinity of the control unit to provide a control input that is interpreted by the control unit 1 and transmitted to an external aid, such as a computer or an electrically controlled device.

1. A control input system operable to control a device, the control input system comprising:
an input unit comprising:
a ferromagnetic material medium; and
a non-invasive detachable hand coupler configured to couple the ferromagnetic material medium to a portion of a hand of a user, the ferromagnetic material medium being operable to generate a magnetic field;
a control unit comprising:
an input interface surface extending in a plane;
a plurality of sensor elements positioned below the input interface surface, the sensor elements being operable to independently sense the magnetic field, the sensor elements comprising:
(a) a first sensor element associated with a first type of output of the device, the first sensor element being operable within a first sense zone located above the input interface surface, wherein the first sensor element produces a first sensor output signal as a result of the ferromagnetic material medium being positioned within the first sense zone;
(b) a second sensor element associated with a second type of output of the device, the second sensor element being operable within a second sense zone located above the input interface surface, wherein the second sensor element produces a second sensor output signal as a result of the ferromagnetic material medium being positioned within the second sense zone;
a signal processor operable to:
(a) convert the first sensor output signal to a first control output signal after the first sensor output signal is produced; and
(b) convert the second sensor output signal to a second control output signal after the second sensor output signal is produced;
a signal transmitter operable to transmit the first and second control output signals to the device; and
a housing which: (a) supports the input interface surface and the signal transmitter; and (b) houses the sensor elements and the signal processor;
wherein moving the input unit into the first sense zone while the input unit has no physical contact with the control unit, causes the first sensor Output signal to be produced which causes the device to produce the first type of output; and
wherein moving the input unit into the second sense zone while the input unit has no physical contact with the control unit, causes the second sensor output signal to be produced which causes the device to produce the second type of output.

2. The control input system of claim 1, wherein the control unit further comprises a control unit coupler configured to couple the control unit to a structure selected from the group consisting of: (a) a body part of the user; (b) the device; and (c) any other structure.

3. The control input system claim 2, wherein the control unit coupler comprises a mount portion, wherein the control input system comprises a hand grip configured to be coupled to the mount portion.

4. The control input system of claim 3, wherein the hand grip has an elongated shape, wherein a first portion of the hand grip is configured to engage a palm of the hand of the user, and wherein a second portion of the hand grip defines a plurality of peaks and valleys, wherein the valleys are configured to engage a plurality of fingers of the hand of the user.

5. The control input system of claim 2, wherein the control unit coupler comprises a loop arranged to enclose a finger of the hand so as to attach the control unit to the finger of the user.

6. The control input system of claim 2, wherein the non-invasive detachable hand coupler is configured to attach the input unit to a tip of a finger of the user.

7. The control input system of claim 1 wherein each one of the first and second sensor elements comprises a coil wherein the control unit is operable to determine a physical position of the ferromagnetic material medium relative to the coils in a two dimensional plane.

8. The control input system of claim 1, wherein a plurality of portions of the first and second sensor elements are located apart from each other in a common plane that passes through the first and second sensor elements, the common plane being located below the plane of the input interface surface, the locations of the first and second sensor elements causing the first and second sense zones to be discrete sense zones, wherein a physical position of the ferromagnetic material medium relative to the discrete sense zones can be determined to ensure that the position of the ferromagnetic material medium causes the first and second control output signals to be produced at different times.

9. The control input system of claim 1, wherein the input interface surface comprises a first section over the first sensor element and a second section over the second sensor element, the first section comprising a descriptor which provides information related to the first type of output.

10. (canceled)

11. The control input system of claim 1, wherein:
the production of the first sensor output signal continues after the input unit has established physical contact with the control unit; and
the production of the second sensor output signal continues after the input unit has established physical contact with the control unit.

12. A control input system comprising:
an input device comprising:
(a) a support configured to be coupled to a portion of a hand of a user; and
(b) a magnet supported by the support, the magnet being configured to generate a magnetic field; and
a control device comprising:
(a) a housing comprising a first housing section and a second housing section;
(b) a first sensor element positioned within the first housing section, the first sensor element being operable to sense presence of the magnetic field within a first space located outside of the housing and above the first sensor element, the first sensor element being associated with an operational outcome of an electrical apparatus; and
(c) a second sensor element positioned within the second housing section, the second sensor element being operable to sense presence of the magnetic field within a second space located outside of the housing and above the second sensor element, the second sensor element being associated with direction of movement of the electrical apparatus;
wherein the first sensor element is configured to generate a first signal in response to the magnet being located within the first space, the first signal configured to control the operational outcome when the electrical apparatus is operably coupled to the control device; and
wherein the second sensor element is configured to generate a second signal in response to the magnet being located within the second space, the second signal configured to control the direction of movement when the electrical apparatus is operably coupled to the control device.

13. The control input system of claim 12, wherein:
the portion of the hand comprises a finger, the finger comprising a finger tip; and
the support defines a cavity configured to at least partially receive the finger tip.

14. The control input system of claim 13, wherein the operational outcome is selected from the group consisting of: (a) a display device output wherein the electrical apparatus comprises a display device; (b) a keyboard input wherein the electrical apparatus is operable to receive keyboard inputs; (c) braking of the electrical apparatus to stop movement of the electrical apparatus; (d) turning indication to indicate turning of the electrical apparatus; and (e) a honking sound of the electrical apparatus wherein the electrical apparatus comprises a horn operable to honk.

15. The control input system of claim 14, wherein the direction of movement comprises forward, backward, right turn and left turn.

16. The control input system of claim 15, wherein:
(a) the control device comprises an additional first sensor element positioned within the first housing section, the additional first sensor element being operable to sense presence of the magnetic field within an additional first space located outside of the housing and above the additional first sensor element, the additional first sensor element being associated with an additional operational outcome of the electrical apparatus; and
(b) the control device comprises an additional second sensor element positioned within the second housing section, the additional second sensor element being operable to sense presence of the magnetic field within an additional second space located outside of the housing and above the additional second sensor element, the additional second sensor element being associated with direction of movement of the electrical apparatus;
(c) the second sensor element is associated with at least one of forward movement and backward movement of the electrical apparatus;
(d) the additional second sensor element is associated with at least one of left turning and right turning of the electrical apparatus;
(e) the additional first sensor element is configured to generate an additional first signal in response to the magnet being located within the additional first space, the additional first signal configured to control the additional operational outcome when the electrical apparatus is operably coupled to the control device; and
(f) the second signal is configured to control at least one of forward movement and backward movement of the electrical apparatus; and
(g) the additional second sensor element is configured to generate an additional second signal in response to the magnet being located within the additional second space, the additional second signal configured to control the turning of the electrical apparatus when the electrical apparatus is operably coupled to the control device.

17. A control input system comprising:
a housing comprising a top surface, a first housing section and a second housing section;
a plurality of first sensor elements positioned within the first housing section, each one of the first sensor elements being:
(a) operable to sense presence of a magnetic field within a first space located above the top surface;
(b) associated with an operational outcome of an electrical apparatus, the magnetic field being generated by a magnet attached to a body part of a user; and a plurality of second sensor elements positioned within the second housing section, each one of the second sensor elements being:
(a) operable to sense presence of the magnetic field within a second space located above the top surface;
(b) associated with a direction of movement of the electrical apparatus;
wherein the first sensor elements are configured to generate different first signals depending upon which first space the magnet is located within, the different first signals configured to control the operational outcomes when the electrical apparatus is operably coupled to the control device; and
wherein the second sensor element is configured to generate different second signals depending upon which second space the magnet is located within, the different second signals configured to control the direction of movement when the electrical apparatus is operably coupled to the control device.

18. The control input system of claim 17, which comprises an input device, the input device comprising a personal attachment configured to be removably coupled to a portion of a hand of a user, wherein the personal attachment holds the magnet.

19. The control input system of claim 17, wherein the body part comprises a finger tip of the user, the personal attachment defining a cavity configured to receive at least part of the finger tip.

20. The control input system of claim 17, wherein the top surface comprises a first surface section located above the first housing section, and the top surface comprises a second surface section located above the second housing section, the second surface section comprising a directional indicator comprising a forward-rearward indicator extending along a first axis and a turning indicator extending along a second axis that intersects with the first axis.

21. The control input system of claim 17, wherein:
(a) the top surface comprises a first surface section located above the first housing section;
(b) the top surface comprises a second surface section located above the second housing section;
(c) the first surface section comprises a plurality of operational descriptors which provide information related to effects of the different first signals; and
(d) the second surface section comprises a plurality of directional descriptors which provide information related to effects of the different second signals.

22. The control input system of claim 17, wherein the operational descriptors are selected from the group consisting of a label and a tactile member.
